(19) United States
(12) Patent Application Publication
(10) Pub. No.: US 2023/0306134 A1
(43) Pub. Date: Sep. 28, 2023

(54) MANAGING IMPLEMENTATION OF DATA CONTROLS FOR COMPUTING SYSTEMS

(71) Applicant: OneTrust, LLC, Atlanta, GA (US)

(72) Inventors: Vinayak S. Milind, Bangalore (IN); Bhyruva S. Gangadharaiah, Bangalore (IN)

(73) Assignee: OneTrust, LLC, Atlanta, GA (US)

(21) Appl. No.: 18/189,767

(22) Filed: Mar. 24, 2023

Related U.S. Application Data
(60) Provisional application No. 63/323,638, filed on Mar. 25, 2022.

(51) Int. Cl. G06F 21/62; G06F 40/40

(52) U.S. Cl. CPC G06F 21/6245; G06F 40/40

(57) ABSTRACT

In general, various aspects of the present invention provide methods, apparatuses, systems, computing devices, computing entities, and/or the like for managing implementation of data controls for computing systems. In various aspects, a method is provided that comprises: comparing a first version of a dataset describing a regulatory framework to a second version of the dataset to identify a change to a data control; in response: processing, using a featurization technique, a portion of the dataset to generate a feature representation of the change that comprises feature attributes representing the change; processing, using a first machine-learning model, the feature representation to generate tags representing characteristics of the change; processing, using a second machine-learning model, the tags to generate an applicable domain; identifying, based on the domain, a computing system affected by the change; and in response, coordinating an action to be performed for the computing system to address the change.

### CROSS-REFERENCE TO RELATED APPLICATIONS

This application claims the benefit of U.S. Provisional Patent Application Ser. No. 63/323,638, filed Mar. 25, 2022, the entire disclosure of which is hereby incorporated herein by reference in its entirety.

### TECHNICAL FIELD

The present disclosure is generally related to data processing systems and methods for retrieving data stored in various data sources on data controls, and organizing and inter-relating the data for recognizing changes made to the data controls.

### BACKGROUND

Computing systems handling (e.g., collecting, receiving, transmitting, storing, processing, sharing, and/or the like) certain types of data must function with particular data controls in place to ensure these certain types of data are handled in a manner that is secure from experiencing data-related incidents such as data breaches, data thefts, unintended data exposures, and/or the like. For example, a particular computing system operated by an entity (e.g., organization) may collect credit card data from visitors to the entity's e-commerce website who are making purchases on the website. Here, the particular computing system must ensure certain data controls are in place to prevent the collected credit card data from being breached by unauthorized parties who may then use the credit card data for nefarious purposes.

However, as technologies advance, the requirements for ensuring computing systems' secure handling of certain types of data can change. Therefore, computing systems must also be managed to ensure that the data controls that have been implemented are properly maintained and/or are up to date to further ensure these certain types of data are handled in a manner that is secure from experiencing data-related incidents.

For example, as Artificial Intelligence (AI) technologies utilized by hackers in gaining access to unauthorized data become more sophisticated, the data controls needed to be implemented by a computing system to combat use of these AI technologies can change. In response, updates (e.g., changes) are often made to regulatory frameworks (e.g., defined within regulatory standards, regulations, and/or laws) that are designed to aid entities in ensuring that the proper data controls are in place to address these technological advances. These regulatory frameworks can define appropriate technical and organizational measures (e.g., data controls) needed to secure certain types of data. Accordingly, updates to these frameworks can directly affect a computing system's handling of particular data. For example, an update to a regulatory framework may involve adding or modifying a data control. In another example, an update to a regulatory framework may involve adding or modifying a control action for implementing a data control. Often, such updates (e.g., changes) may occur without an entity's knowledge of the update, and how the update affects computing systems of the entity in handling the particular data. As a result, the computing systems affected by the update can become more vulnerable to experiencing data-related incidents.

Accordingly, significant technical challenges can arise for an entity in assuring that computing systems for the entity are managed and operating in a secure manner with respect to handling certain types of data. For example, due to the enormous complexity and scale of many large data processing operations utilized by an entity in handling particular data (such as the credit card processing example discussed above), as well as the number of data controls defined through various regulatory frameworks that may apply to the data processing operations, an entity may find it extremely challenging in recognizing a change has been made to an applicable regulatory framework and how the change affects data processing operations for the entity. This can be because the data processing operations involved in handling the particular data may utilize a number of computing systems that are complex in scope and use a number of various computing components in processing the particular data. Therefore, any change made to a regulatory framework can be a challenge in recognizing what computing systems are affected by the change, as well as what actions should be taken for the affected computing systems in light of the change. Further, the fact that the data processing operations may occur over different jurisdictions, which may invoke different applicable regulatory frameworks and/or applications thereof, adds significantly to the technical challenges associated with complying with the applicable regulatory frameworks.

### SUMMARY

In general, various aspects of the present disclosure provide methods, apparatuses, systems, computing devices, computing entities, and/or the like for managing implementation of data controls for computing systems of various entities. In accordance with various aspects, a method is provided. Accordingly, the method comprises: comparing, by computing hardware, a first version of a dataset describing a regulatory framework to a second version of the dataset describing the regulatory framework to identify a change to a data control defined in the regulatory framework, wherein the data control is used in handling target data; responsive to identifying the change to the data control: processing, by the computing hardware and using a featurization technique, at least a portion of the dataset describing the regulatory framework to generate a feature representation of the change to the data control, wherein the portion of the dataset comprises content on the change to the data control and the feature representation comprises a plurality of feature attributes representing the content of the change to the data control; processing, by the computing hardware and using a first machine-learning model, the feature representation of the change of the data control to generate a plurality of tags, wherein the plurality of tags represents characteristics of the change made to the data control; processing, by the computing hardware and using a second machine-learning model, the plurality of tags to generate at least one of an applicable domain or an applicable jurisdiction for the data control; identifying, by the computing hardware and based on the at least one of the applicable domain or the applicable jurisdiction, a computing system used in handling the target data that is affected by the change to the data control; and responsive to identifying the computing system, coordinating, by the computing hardware, an action to be performed with respect to the computing system to address the change to the data control.

In some aspects, the change to the data control comprises an addition of a control action performed for implementing the data control and the action comprises automatically setting up a task to have the control action performed on the computing system. In some aspects, the change to the data control comprises a modification to a control action performed for implementing the data control and the action comprises automatically setting up a task to have the modification of the control action performed on the computing system.

In some aspects, the action comprises sending an electronic notification of the change to the data control to an entity associated with the computing system. In some aspects, the method further comprises determining, by the computing hardware, a priority level associated with the change to the data control, wherein the priority level is based on a requirement for implementing the change to the data control and at least one of a timing for sending the electronic notification or a recipient of the electronic notification is based on the priority level. In additional or alternative aspects, the action comprises: identifying, by the computing hardware, the change in the data control comprises a new control action needed to be performed to implement the data control; and sending an electronic notification comprising a recommendation based on the new control action to an entity associated with the computing system. In some aspects, the action is performed based on identifying the regulatory framework from a subscription profile for an entity associated with the computing system.

In some aspects, identifying, based on the at least one of the applicable domain or the applicable jurisdiction, the computing system used in handling the target data that is affected by the change to the data control comprises: retrieving a subscription profile of an entity associated with the computing system, wherein the subscription profile identifies at least one of a domain in which the entity operates or a jurisdiction in which the computing system is located; and comparing at least one of the applicable domain to the domain or the applicable jurisdiction to the jurisdiction to determine a match between the at least one of the applicable domain and the domain or the applicable jurisdiction and the jurisdiction.

In accordance with various aspects, a system is provided comprising a non-transitory computer-readable medium storing instructions and a processing device communicatively coupled to the non-transitory computer-readable medium. The processing device is configured to execute the instructions and thereby perform operations comprising: comparing a first version of a dataset describing a regulatory framework to a second version of the dataset describing the regulatory framework to identify a change to a data control defined in the regulatory framework, wherein the data control is used in handling target data; responsive to identifying the change to the data control: processing, using a featurization technique, at least a portion of the dataset describing the regulatory framework to generate a feature representation of the change to the data control, wherein the feature representation comprises a plurality of feature attributes representing at least the portion of the dataset; processing, using a first machine-learning model, the feature representation of the change of the data control to generate a plurality of tags, wherein the plurality of tags represents characteristics of the change made to the data control; processing, using a second machine-learning model, the plurality of tags to generate at least one of an applicable domain or an applicable jurisdiction for the data control; identifying, based on the at least one of the applicable domain or the applicable jurisdiction, a computing system used in handling the target data that may be affected by the change to the data control; and responsive to identifying the computing system, coordinating an action to be performed with respect to the computing system to address the change to the data control.

In some aspects, the change to the data control comprises at least one of an addition of or modification to a control action performed for implementing the data control and the action comprises automatically setting up a task to have the control action performed on the computing system. In some aspects, the operations further comprise determining a priority level associated with the change to the data control, and coordinating the action to be performed is based on the priority level. In some aspects, the action comprises sending an electronic notification of the change to the data control to an entity associated with the computing system. In additional or alternative aspects, the action comprises sending an electronic notification comprising a recommendation based on the change to the data control to an entity associated with the computing system. In some aspects, the action is performed based on identifying the regulatory framework from a subscription profile for an entity associated with the computing system.

In some aspects, identifying, based on the at least one of the applicable domain or the applicable jurisdiction, the computing system used in handling the target data that may be affected by the change to the data control comprises: retrieving a subscription profile of an entity associated with the computing system, wherein the subscription profile identifies at least one of a domain in which the entity operates or a jurisdiction in which the computing system is located; and comparing at least one of the applicable domain to the domain or the applicable jurisdiction to the jurisdiction to determine a match between the at least one of the applicable domain and the domain or the applicable jurisdiction and the jurisdiction.

In accordance with various aspects, a non-transitory computer-readable medium storing computer-executable instructions is provided. The computer-executable instructions, when executed by computing hardware, configure the computing hardware to perform operations comprising: comparing a first version of a regulatory framework to a second version of the regulatory framework to identify a change to a data control defined in the regulatory framework; responsive to identifying the change to the data control: processing at least a portion of the regulatory framework to generate a feature representation of the change to the data control, wherein the portion of the regulatory framework comprises content on the change to the data control and the feature representation comprises a plurality of feature attributes representing the content of the change to the data control; processing the feature representation of the change of the data control to generate a plurality of tags, wherein the plurality of tags represents characteristics of the change made to the data control; processing the plurality of tags to generate at least one of an applicable domain or an applicable jurisdiction for the data control; identifying, based on the at least one of the applicable domain or the applicable jurisdiction, a computing system that is affected by the change to the data control; and responsive to identifying the computing system, coordinating an action to be performed with respect to the computing system to address the change to the data control.

In some aspects, the change to the data control comprises at least one of an addition of or a modification to a control action performed for implementing the data control and the action comprises automatically setting up a task to have the control action performed on the computing system. In some aspects, the operations further comprise determining a priority level associated with the change to the data control that is based on a requirement for implementing the change to the data control, and at least one of a timing for sending the electronic notification or a recipient of the electronic notification is based on the priority level. In some aspects, the action comprises sending an electronic notification of the change to the data control to an entity associated with the computing system.

In some aspects, identifying, based on the at least one of the applicable domain or the applicable jurisdiction, the computing system that is affected by the change to the data control comprises: retrieving a subscription profile of an entity associated with the computing system, wherein the subscription profile identifies at least one of a domain in which the entity operates or a jurisdiction in which the computing system is located; and comparing at least one of the applicable domain to the domain or the applicable jurisdiction to the jurisdiction to determine a match between the at least one of the applicable domain and the domain or the applicable jurisdiction and the jurisdiction.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for managing implementation of data controls for computing systems in accordance with various aspects of the present disclosure;

FIG. 2 depicts an example of a process for monitoring for changes to regulatory frameworks and having action(s) performed due to a change to a regulatory framework affecting one or more computing systems in accordance with various aspects of the present disclosure;

FIG. 3 depicts an example of a process for detecting a change to a regulatory framework in accordance with various aspects of the present disclosure;

FIG. 4 depicts an example of a process for processing a change to a regulatory framework in accordance with various aspects of the present disclosure;

FIG. 5 depicts an example of a process for having action(s) performed for a change to a regulatory framework in accordance with various aspects of the present disclosure;

FIG. 6 depicts an example of a process for identifying recommendations in accordance with various aspects of the present disclosure;

FIG. 7 depicts an example of a system architecture that may be used in accordance with various aspects of the present disclosure; and

FIG. 8 depicts an example of a computing entity that may be used in accordance with various aspects of the present disclosure.

### DETAILED DESCRIPTION

### Overview

As previously noted, computing systems handling (e.g., collecting, receiving, transmitting, storing, processing, sharing, and/or the like) certain types of data must function with particular controls in place to ensure these certain types of data are handled in a manner that is secure from the computing systems experiencing data-related incidents such as data breaches, data thefts, unintended data exposures, and/or the like. For example, computing systems performing functionality that involves handling personal and/or sensitive data of individuals (e.g., personally identifiable information (PII)) are required to have certain controls in place for the functionality to ensure the security of the personal and/or sensitive data so that the data is not exposed to a data-related incident.

However, as technologies advance, the requirements for ensuring computing systems' secure handling of certain types of data can change. Therefore, computing systems must also be managed to ensure that the data controls that have been implemented are properly maintained and/or are up to date to further ensure these certain types of data are handled in a manner that is secure from experiencing data-related incidents.

In response to technological advances, updates (e.g., changes) are often made to regulatory frameworks (e.g., defined within regulatory standards, regulations, and/or laws) that are designed to aid entities in ensuring that the proper data controls are in place to address these technological advances. These regulatory frameworks can define appropriate technical and organizational measures (e.g., data controls) needed to secure certain types of data. Accordingly, updates to these frameworks can directly affect a computing system's handling of particular data. For example, an update to a regulatory framework may involve adding or modifying a data control. In another example, an update to a regulatory framework may involve adding or modifying a control action for implementing a data control. Often, such updates (e.g., changes) may occur without an entity's knowledge of the update, and how the update affects computing systems of the entity in handling the particular data. As a result, the computing systems affected by the update can become more vulnerable to experiencing data-related incidents.

As a particular example, as ransomware technologies have advanced and ransomware attacks are initiated more frequently on various computing systems, many regulatory institutions have cause to change regulatory frameworks to define data controls for addressing such attacks. Accordingly, an entity's implementation of these new data controls on computing systems involved in handling certain types of data can be crucial in operating these computing systems in a secure manner that minimizes the threat of these ransomware attacks. Therefore, the entity's knowledge of a change to an applicable regulatory frameworks in defining these new data controls, and how the change affects the computing systems of the entity in handling the particular data, is critical in the entity correctly implementing the new data controls within the applicable computing systems.

However, significant technical challenges can arise for an entity in assuring that computing systems for the entity are operating in a secure manner with respect to the computing systems' handling of certain types of data. For example, due to the enormous complexity and scale of many large data processing operations utilized by an entity in handling particular data (e.g., such as processing credit card data), as well as the number of data controls defined through various regulatory frameworks that may apply to the data processing operations, an entity may find it extremely challenging in recognizing that a change has been made to an applicable regulatory framework and how the change affects data processing operations for the entity. This can be because the data processing operations involved in the handling of the particular data may utilize a number of computing systems that are complex in scope and make use of various computing components in processing the particular data.

These technical challenges are further exacerbated in the fact that there is a lack of development of systems, processes, and/or technologies to assist an entity in recognizing when a change has been made to an applicable regulatory framework. In addition, there is a lack of development of systems, processes, and/or technologies to assist an entity in recognizing what computing systems of the entity are affected by a change, and how these computing systems are affected by the change. Further, there is a lack of development of systems, processes, and/or technologies to assist and entity in identifying and implementing data controls and actions to address the change.

Therefore, any change made to a regulatory framework can prove to be a significant challenge to an entity in recognizing what computing systems of the entity are affected by the change, as well as what actions should be taken for the affected computing systems in light of the change. Further, the fact that the data processing operations for the entity may occur over different jurisdictions, which may invoke different applicable regulatory frameworks and/or applications thereof, adds significantly to the technical challenges associated with successfully implementing regulatory frameworks for various computing systems, as well as maintaining (managing) the successful implementations as frameworks are updated.

Various aspects of the present disclosure overcome many of the technical challenges associated with managing the recognition and implementation of changes made to regulatory frameworks that affect one or more computing systems, such as those discussed above. Specifically, various aspects of the disclosure are directed to a computer-implemented change detection process for identifying changes made to regulatory frameworks and identifying computing systems affected by those changes. In addition, the computer-implemented change detection process can involve coordinating one or more actions to be performed to address the changes affecting the computing systems.

In various aspects, a change detection computing system is provided to perform the change detection process. In some aspects, the change detection computing system can be tasked with monitoring for changes to different regulatory frameworks, and upon detecting a change to a particular framework, identifying computing systems of entities that may be affected by the change. The change detection computing system may also coordinate having various actions performed, with respect to the computing systems identified as affected by the change, to address the change.

In various aspects, the change detection computing system monitors different data sources to facilitate detection of changes made to different regulatory frameworks. For example, the change detection computing system (or some other computing system) may monitor (e.g., continuously or on a periodic basis) one or more data sources for new data indicating that an applicable regulatory framework has changed. Such data sources may include, for example: (1) data structures that act as repositories of regulatory framework information; (2) publicly available websites (e.g., informational websites that cover privacy-related news); (3) electronic bulletins, such as government or organizational bulletins that are issued to indicate a change in a particular regulatory framework; or (4) any other suitable data source. The change detection computing system's execution of this monitoring process may be automatic in nature and/or manually triggered (e.g., as part of a scheduled batch process). In certain aspects, the change detection system may also include a suitable user interface for receiving information from users (e.g., privacy officers) regarding changes to any applicable regulatory frameworks.

In various aspects, the change detection computing system may include one or more repositories for storing information (e.g., documents) defining the applicable regulatory frameworks. Such storage may help in facilitating the change detection computing system in identifying changes made to the regulatory frameworks. Therefore, the change detection computing system's receipt and/or storage of a new (updated) version of a dataset defining and/or describing an applicable regulatory framework may serve as a trigger event for the change detection computing system to identifying any changes made to the regulatory framework and computing systems that may be affected by the changes.

In certain aspects, the change detection computing system identifies that a change has been made to a regulatory framework by comparing a first version (e.g., updated version) of a dataset containing content on the regulatory framework to a second version (e.g., previous version) of the dataset containing the content on the regulatory framework. For example, the change detection computing system may identify a change to a data control defined in the regulatory framework that is used in handling target data. The change to the data control may involve the data control being added to the regulatory framework or a modification may have been made to the data control in the regulatory framework. For example, a control action used in implementing the data control into a computing system may have been added or modified. The change detection computing system may identify other types of changes such as a new jurisdiction in which the regulatory framework is applicable.

In response to identifying the change to the regulatory framework, the change detection computing system in various aspects processes a portion of the dataset (content thereof) for the regulatory framework that discusses the change (e.g., change to the data control) using a featurization technique, such as bag of words, term frequency-inverse document frequency (TFiDF), Word2Vec, and/or the like, to generate a feature representation of the change to the regulatory framework. In some aspects, the change detection computing system generates the feature representation to include a plurality of feature attributes representing the content of the change to the regulatory framework. For example, the feature representation may be a vector representation that includes a plurality of values in which each value represents an attribute of the text found in the portion of the dataset discussing the data control that has been modified in the regulatory framework.

In various aspects, the change detection computing system processes the feature representation using a first machine-learning model to generate a plurality of tags representing characteristics of the change to the regulatory framework. For example, the change detection computing system may generate a plurality of tags that includes a particular tag identifying a type for a data control that has been modified or added to the framework such as a data access control, a data masking control, a data transfer control, and/or the like. In addition, the change detection computing system may generate a plurality of tags that includes one or more of the tags identifying control actions used in implementing the data control that has been modified or added to the framework within a computing system. For example, a control action may involve implementing two-factor authentication for implementing a data access control. Further, the change detection computing system may generate a plurality of tags that includes one or more tags identifying characteristics of a computing system, or components thereof, to which the data control applies. For example, a particular tag may identify that the data control is applicable to a database implementation, a Web server, a particular software application, and/or the like.

In some aspects, the change detection computing system processes the plurality of tags using a second machine-learning model to generate one or more additional tags identifying applicable domains and/or applicable jurisdictions in which the change to the regulatory framework may apply. A domain may be considered an industry, corporate area, business sector, and/or the like in which an entity (e.g., an organization) operates. For example, an entity may operate in the healthcare domain, the e-commerce domain, the banking domain, the telecommunications domain, and/or the like. The domain(s) in which an entity operates can often define what regulatory frameworks the entity should implement within its computing systems with respect to handling certain types of data. For example, cyber security frameworks applicable to the healthcare and health insurance domains are used to secure the confidentiality, integrity, and authorization of computing systems and PII data include frameworks provided through the National Institute of Standards and Technology (NIST), the HITRUST Alliance, and the Center for Internet Security (CIS).

A jurisdiction identifies a territory, region, district, and/or the like in which a regulatory framework is applicable, as well as where an entity (e.g., computing system thereof) operates. For example, a jurisdiction may include a portion of the World, a country, a region of a country, a state, and/or the like. For example, regulatory frameworks used for implementing data controls for the purpose of adhering to the General Data Protection Regulation (GDPR) are applicable to countries that are members of the European Union (EU).

In various aspects, the change detection computing system identifies the computing systems of various entities that are affected by a change to a regulatory framework upon identifying the change to the regulatory framework, the applicable domain(s), and/or applicable jurisdiction(s). Note that a change to a regulatory framework may not necessarily affect a particular computing system of an entity that has been identified. Therefore, in some aspects, the change detection computing system may identify those computing systems of entities that may be (as opposed to those that necessarily are) affected by the change to the regulatory framework. With that said, the remainder of the disclosure describes the change detection computing system identifying the computing systems of entities that are affected by the change.

In various aspects, the change detection computing system carries out identifying the affected computing systems by identifying those entities having computing systems with functionality that handle the target data and operate in domains and/or jurisdictions that match the applicable domain(s) and/or jurisdiction(s) for the change to the regulatory framework. In addition, the change detection computing system may look at other characteristics identified for the change and other characteristics of the entities in identifying those entities having computing systems affected by the change.

In some aspects, the change detection computing system operates a change detection service to which various entities subscribe. Here, the service monitors for changes made to regulatory frameworks (e.g., changes made to data controls thereof) that are applicable to the entities, and upon detecting changes made to the regulatory frameworks, identifies computing systems associated with the entities that are affected by the changes. In various aspects, the service may allow for an entity to set up a subscription profile upon subscribing to the service. Here, the subscription profile may identify various regulatory frameworks that are applicable to the entity (e.g., the profile may identify the regulatory frameworks that the entity has implemented for various computing systems). In addition, the subscription profile may identify the types of data (e.g., PII) handled by the entity. Further, the subscription profile may identify the domains and/or jurisdictions in which the entity operates. Furthermore, the subscription profile may include more detailed information on the entity such as the various computing systems of the entity that are involved in handling certain types of data, data controls (and/or control actions thereof) defined by the applicable regulatory frameworks that have been implemented within the various computing systems of the entity, which domains and/or jurisdictions the computing systems of the entity operate within, and/or the like.

In various aspects, the change detection computing system uses an entity's subscription profile in determining whether a change to a regulatory framework is applicable to a computing system of the entity. For example, the change detection computing system may compare the applicable domain(s) and/or jurisdiction(s) for the change to the regulatory framework to the domain(s) and/or jurisdiction(s) identified in the entity's subscription profile to determine whether the change to the regulatory framework affects any of the computing systems of the entity handling the target data (e.g., to determine a match between an applicable domain and/or jurisdiction to a domain or jurisdiction found in the subscription profile).

If the change detection computing system identifies a computing system for the entity that is affected by the change to the regulatory framework, then the change detection computing system can coordinate having one or more actions performed with respect to the computing system to address the change to the regulatory framework. According to various aspects, these actions may involve different operations, processes, activities, tasks, and/or the like.

For instance, if the change to the regulatory framework involves an addition of a data control to the framework or a modification to a data control in the framework, then the change detection computing system can coordinate having one or more actions performed that may involve automatically setting up a task to have the data control implemented or implementation thereof modified on the affected computing system. For example, the change detection computing system may automatically set up a task within a management software application used in managing the implementation of various data controls associated with the regulatory framework within computing systems for the entity to have the data control implemented or modified on the affected computing system. In addition, the change detection computing system may assign the task to personnel of the entity who is then responsible for implementing or modifying the data control. Depending on the circumstances, the management software application may be provided within the change detection service to the entity or may be an application solely managed by the entity (e.g., residing within a computing system of the entity).

In other instances, the change detection computing system may coordinate having one or more actions performed that involve sending one or more electronic notifications, such as emails, to personnel of the entity identifying the change to the regulatory framework. Here, the change detection computing system may use the entity's subscription profile in identifying information (e.g., email addresses) of personnel who are to receive the notification(s). In some aspects, the change detection computing system may send notification(s) that include links that may be selected by the personnel to access additional information on the change. In addition or instead, the change detection computing system may send notification(s) that include one or more recommendations on how to address the change to the regulatory framework. For example, the notification(s) may provide a recommendation that a new (additional) control action for a data control needs to be implemented on the affected computing system. Therefore, the recipients (personnel) of the notification(s) can then use the information provided in the notification(s) in addressing the change to the regulatory framework accordingly.

In some aspects, the change detection computing system may coordinate having the action(s) performed based on a priority determined for the change. For example, the change detection computing system may determine a priority for sending notification(s) based on a requirement for implementing the change such as a time requirement, severity requirement (e.g., the change to the data control is deemed highly important to have implemented), a requirement set by the entity (e.g., a requirement set up in the entity's subscription profile), and/or the like. In certain aspects, the priority may establish parameters for having the action(s) performed. For example, the priority may establish parameters for sending the notification(s) such as a time for sending the notification(s) and/or who should be the recipients of the notification(s).

Various aspects of the disclosure provided herein are effective, efficient, timely, and accurate in managing implementation of data controls for computing systems by recognizing changes to regulatory frameworks. In addition, various aspects of the disclosure provided herein can facilitate the identification of changes to regulatory frameworks that can affect various computing systems' handling of target data, as well as the computing systems affected by the changes. Further, various aspects of the disclosure provided herein can facilitate (e.g., coordinate) actions that can be taken to address changes to regulatory frameworks affecting computing systems to ensure that target data is continued to be handled by the computing systems in a secure and/or compliant manner. Furthermore, various aspects of the disclosure can carry out data processing required for data control management purposes that cannot be feasibly performed by a human, especially when such data processing involves large volumes of data relating to various regulatory frameworks, data controls thereof, computing systems of entities, and computing components thereof. This is especially advantageous when the data processing must be carried out over a reasonable (relatively short) timeframe to allow for relevant observations (e.g., identification of changes to regulatory frameworks) to be gathered from the data and/or relevant operations to be performed based on the observations (e.g., relevant actions to be performed to address the changes).

In facilitating effective, efficient, timely, and accurate data control management, various aspects of the present disclosure make major technical contributions to improving the computational efficiency and reliability of various computing systems that are involved in handling target data. This in turn translates to the computing systems operating in a manner that minimizes the risk of the computing systems experiencing a data-related incident such as a data breach, data theft, unintended data exposure, and/or the like. Further detail is now provided for various aspects of the disclosure.

It is noted that reference is made to target data throughout the remainder of the application. However, target data is not necessarily limited to information that may be considered as personal and/or sensitive in nature but may also include other forms of information that may be of interest. For example, target data may include data on a particular subject of interest, such as a political organization, manufactured product, current event, and/or the like. Further, target data may not necessarily be associated with an individual but may be associated with other entities such as a business, organization, government, association, and/or the like.

### Example Computing Environment

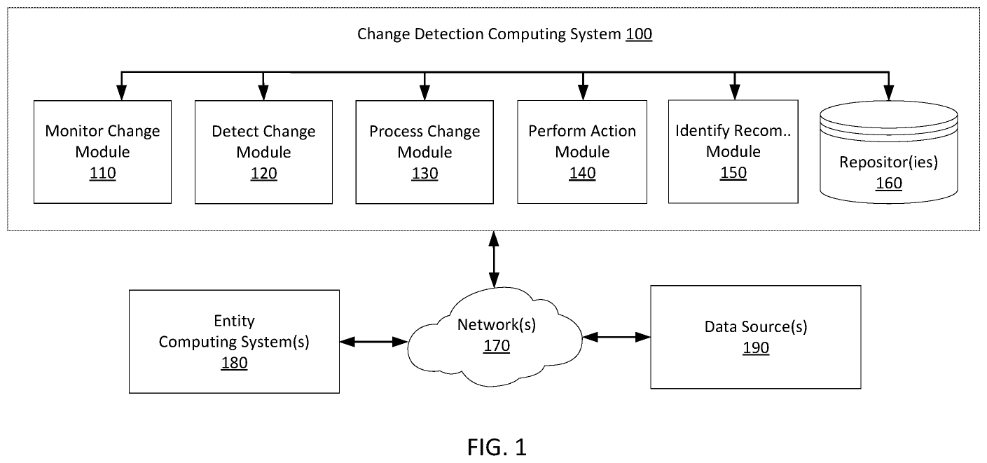

FIG. 1 depicts an example of a computing environment that can be used for managing implementation of data controls affected by changes made to one or more regulatory frameworks for computing systems associated with various entities according to various aspects. As noted above, an entity that handles target data may implement various data controls within computing systems of the entity that are defined by one or more regulatory frameworks to ensure that the target data is handled by the computing systems in a secure manner that avoids data incidents such as data breaches, data thefts, unintended data exposures, and/or the like. For example, an entity may be collecting credit card data from individuals and storing the credit card data in a database found in a computing system of the entity. Here, the entity may have implemented a data control for the computing system that involves a control action of encrypting the credit card data that is stored in the database. Accordingly, the type of encryption employed by the entity (e.g., control action carried out to implement the encryption data control) may be defined by an applicable regulatory framework. Therefore, the entity may be interested in knowing if any changes are made to the regulatory framework (e.g., any changes are made to the encryption data control) that may affect the computing system's handling of the credit card data.

The term “handling” is used throughout the remainder of the specification in discussing various aspects of the disclosure with managing implementation of data controls within computing systems handling target data. Those of ordinary skill in the art should understand that “handling” may involve performing any of various types of activities in regard to the target data such as processing, collecting, accessing, storing, retrieving, revising, and/or deleting, and/or the like the target data.

A change detection computing system 100 may be provided that includes software components and/or hardware components for managing detection and identification of changes made to one or more applicable regulatory frameworks implemented within one or more computing systems 180 of various entities, as well as the computing system(s) 180 affected by the changes. The change detection computing system 100 may provide a change detection service that is accessible over one or more networks 170 (e.g., the Internet) by an entity (e.g., a computing system 180 associated with the entity). Here, personnel of the entity may access the service over the one or more networks 170 through one or more graphical user interfaces (e.g., webpages) and use the service in managing detection and identification of changes to regulatory frameworks applicable to the entity, as well as identifying those computing systems 180 of the entity that are affected by the changes.

In various aspects, the change detection computing system 100 enables an entity to subscribe to the service and in doing so, set up a subscription profile through the graphical user interface(s). The subscription profile may identify those regulatory framework(s) that are applicable (e.g., important) to the entity. For example, the subscription profile may identify those regulatory framework(s) in which the entity would like to have monitored for changes made to the framework(s). In addition, the subscription profile may identity the computing system(s) 180 for the entity and/or what target data is being handled by the computing system(s) 180. That is, the subscription profile may identify those computing system(s) 180 of the entity that the entity would like to know are affected by any changes made to the applicable regulatory framework(s). Further, the subscription profile may identify the various data controls, and/or control actions thereof, defined by the applicable regulatory framework(s) that have been implemented by the entity within the computing system(s) 180. According to various aspects, the change detection computing system 100 may use such information found in the entity's subscription profile in identifying those changes to regulatory frameworks the entity would like to be made aware of, as well as what computing system(s) 180 of the entity that are affected by the changes.

In addition, the entity's subscription profile may include preference information for the entity. For instance, the subscription profile may identify the preferred actions to be carried out for a change to a regulatory framework identified for the entity that may affect a computing system 180 of the entity. For example, the preferred action may be to send one or more notifications of the change to particular personnel of the entity along with a recommendation for addressing the change. Further, the subscription profile may include priority information on carrying out the preferred actions. For instance, the priority information may identify a timing requirement for having preferred actions performed, a severity requirement for having the preferred actions performed, and/or personnel requirements for who is responsible for performing the preferred actions.

For example, a timing requirement may indicate that the change detection computing system 100 should send a notification immediately if the change needs to be addressed within thirty days or the change detection computing system 100 should send the notification within two weeks if longer than thirty days. A severity requirement may indicate that the change detection computing system 100 should send a notification to personnel of the entity if the severity of the change satisfies a certain threshold (e.g., high, or medium, as opposed to low) with respect to its effect on a computing system 180 of the entity. A personnel requirement may indicate that the change detection computing system 100 send a notification to first personnel (e.g., a privacy officer) if the severity of the change is high and should send the notification to second personal (e.g., a system administrator) if the severity of the change is medium or low. Accordingly, the priority for a change to a regulatory framework may be set based on any one of these requirements or combination thereof.

In addition to the graphical user interfaces, the change detection computing system 100 may include one or more interfaces (e.g., application programming interfaces (APIs)) for communicating and/or accessing the computing system(s) 180 of the entities over the network(s) 170. For instance, the change detection computing system 100 may access a computing system 180 for an entity via one of the interfaces to communication with a software application within the entity computing system 180 to have one or more actions performed with respect to a change to a regulatory framework. For example, the change detection computing system 100 may access a data control management software application to set up a task to have performed for a change to a regulatory framework that involves a data control defined by the framework that is implemented within a computing system 180 of the entity.

In various aspects, the change detection computing system 100 may comprise computing hardware performing a number of different processes in monitoring changes to regulatory frameworks that may affect computing systems 180 of the entities. In some aspects, the change detection computing system 100 executes a monitor change module 110 in monitoring for changes to applicable regulatory frameworks for the entities. As further detailed herein, the change detection computing system 100 executes the monitor change module 110 to monitor various data sources 190 in detecting changes made to regulatory frameworks.

For example, the various data sources 190 may include: (1) data structures that act as repositories of regulatory framework information; (2) publicly available websites (e.g., informational websites that cover privacy-related news); (3) electronic bulletins, such as government or organizational bulletins that are issued to indicate a change in a particular regulatory framework; or (4) any other suitable data source. The change detection computing system 100 may detect that a document on a particular regulatory framework has been updated (e.g., a new version of the document exists), a new bulletin on a particular regulatory framework has been posted, a new article on a particular regulatory framework has been published, and/or the like. In other instances, the change detection computing system 100 may receive updates from the different data sources 190. Yet, in other instances, the change detection computing system 100 may routinely retrieve content from a data source 190 and then evaluate the content to determine whether any changes have been made to the content. In some aspects, the change detection computing system 100 may store the content (e.g., documents, bulletins, articles, and/or the like) on the regulatory frameworks obtained from the various data sources 190 in one or more data repositories 160 within the change detection computing system 100.

In various aspects, the monitor change module 110, upon detecting a change to a particular framework, processes the change to identify those computing systems 180 of the entities that may be affected by the change. The monitor change module 110 may then have one or more actions performed for the affected entity computing systems 180 to address the change.

In various aspects, the change detection computing system 100 includes, in addition to or instead of, a detect change module 120. The change detection computing system 100 can use the detect change module 120 for evaluating content (e.g., a dataset) obtained on a regulatory framework to determine whether a change has been made to the content. For example, the detect change module may conduct a comparison of a first version of the content (e.g., an updated version of the content) with a second version of the content (e.g., a previous version of the content) to detect any changes made to the content. Here, the content may be comprised of text on the regulatory framework and the detect change module 120 conducts a comparison of the text for the first and second versions of the content to detect changes in the text. In turn, such changes in the text may constitute changes made to the regulatory framework.

In various aspects, the change detection computing system 100 includes, in addition to or instead of, a process change module 130 that is used in processing a change identified for a regulatory framework to identify characteristics of the change such as a particular data control defined by the regulatory framework to which the change applies, types of systems affected by the change, applicable domains subject to the change, applicable jurisdictions subject to the change, and/or the like. In particular aspects, the process change module 130 performs the processing of the change by using multiple machine-learning models in identifying the characteristics of the change. The change detection computing system 100 can then use the characteristics of the change in identifying the computing systems 180 of various entities that are affected by the change.

In various aspects, the change detection computing system 100 includes, in addition to or instead of, a perform action module 140 that is used to have one or more actions performed to address a change to a regulatory framework for a computing system 180 of an entity affected by the change. As previously noted, these actions may include having various processes, tasks, operations, and/or the like performed to address the change to the regulatory framework. In addition, the actions may be based on preferences identified in a subscription profile for the entity. For instance, an action may entail a task that is to be performed to implement the change within the affected entity computing system 180. For example, the perform action module 140 may set up the task to implement the change within some type of software application that is used in managing the implementation of data controls defined by the regulatory framework. In addition, the perform action module 140 may assign the task to particular personnel of the entity and/or have one or more automated operations performed that involve implementing the change within the affected entity computing system 180.

In other instances, an action may entail sending one or more (electronic) notifications to the entity (personnel thereof) identifying the change to the regulatory framework. For example, the perform action module 140 may have emails sent to personnel of the entity. According to some aspects, the notification(s) may include various information on the change. In addition, the notification(s) may include, in addition or instead, one or more recommendations for addressing the change. Further, the notification(s) may include, in addition or instead, one or more links that an individual may select to access various information on the change and/or recommendations to address the change. The perform action module 140 may have other types of actions performed according to other aspects of the disclosure.

Finally, in various aspects, the change detection computing system 100 includes, in addition to or instead of, an identify recommendation module 150 that is used to identify one or more recommendations to address a change to a regulatory framework to send to an entity for a computing system 180 of the entity that may be affected by the change. In some aspects, the identify recommendation module 150 may consider what data controls (and/or control actions thereof) the entity has implemented for the affected entity computing system 180 and identify appropriate recommendation(s) for addressing the change accordingly. Further detail is provided below regarding the configuration and functionality of the monitor change module 110, detect change module 120, process change module 130, perform action module 140, and identify recommendation module 150 according to various aspects of the disclosure.

### Monitor Change Module

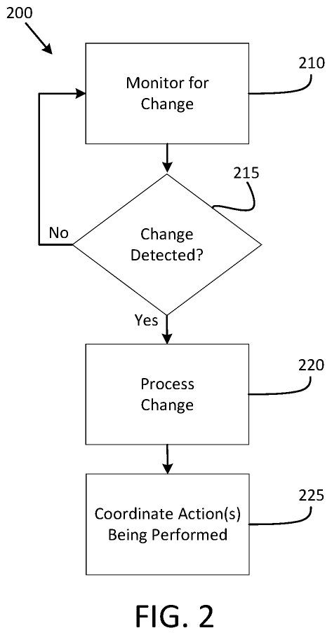

Turning now to FIG. 2, additional details are provided regarding a monitor change module 110 for monitoring changes made to regulatory frameworks and having action(s) performed due to a change to a regulatory framework affecting one or more computing systems in accordance with various aspects of the disclosure. For instance, the flow diagram shown in FIG. 2 may correspond to operations carried out, for example, by computing hardware found in the change detection computing system 100 as described herein, as the computing hardware executes the monitor change module 110.

The change detection computing system 100 may monitor various data sources 190 that provide content on the regulatory frameworks. In various aspects, the change detection computing system 100 retrieves and/or receives new (updated) content on a particular regulatory framework and in turn, stores the new (updated) content in one or more data repositories 160 in a dataset for the regulatory framework. In some instances, the dataset for the regulatory framework may include content provided by more than one data source 190. For example, the dataset may include content on the data controls, and/or control actions thereof, defined for the regulatory framework along with bulletins on updates may to the framework that have been published by the organization responsible for maintaining the framework. In other instances, the dataset may include content from a single data source. In these instances, multiple datasets may be stored in the repositories 160 for the regulatory framework.

In various aspects, the process 200 involves the monitor change module 110 monitoring for a change to a regulatory framework in Operation 210. In some aspects, the monitor change module 110 performs this operation by detecting that a new (updated) version of a dataset has been added to the data repositories 160 for the regulatory framework. In other aspects, the monitor change module 110 performs this operation by receiving an indication that a new (updated) version of a dataset is available for the regulatory framework. For example, the change detection computing system 100 may receive new (updated) content for the regulatory framework and store the content as a new version of a dataset for the regulatory framework in a particular repository 160. Upon saving the content as a new (updated) version of the dataset, the change detection computing system 100 may then send an indication to the monitor change module 110 that a new (updated) version of the dataset is available for the regulatory framework.

In Operation 215, the monitor change module 110 determines whether one or more changes have been made to the regulatory framework. In various aspects, the monitor change module 110 performs this particular operation by invoking a detect change module 120. The detect change module 120 evaluates the new (updated) version of the dataset for the regulatory framework to determine whether content found in the dataset identifies one or more changes that have been made to the regulatory framework. In some aspects, the detect change module 120 evaluates the new (updated) version of the dataset by comparing the new (updated) version of the dataset with a previous version of the dataset to identify changes between the two versions of the dataset. For example, the previous version of the dataset may be the version of the dataset created upon receiving new (updated) content for the regulatory framework previously. If the detect change module 120 identifies a change between the two versions of the dataset, then the detect change module 120 reports the change to the monitor change module 110.

In Operation 220, the monitor change module 110 processes each of the changes identified for the regulatory framework. In various aspects, the monitor change module 110 performs this particular operation by invoking a process change module 130 for each of the changes identified for the regulatory framework. In turn, the process change module 130 processes a change identified for the regulatory framework by identifying characteristics of the change. In particular aspects, the process change module 130 processes at least a portion of the dataset (e.g., content therein) that provides detail on the change to generate one or more tags that identify the characteristics of the change.

For example, the change to the regulatory framework may entail a modification that has been made to a data control defined by the regulatory framework. Therefore, in this example, the one or more tags may provide characteristics of the change made to the data control such as a type for the data control, one or more control actions are that performed for implementing the data control, one or more types of entity computing systems 180 to which the data control is applicable, and/or the like.

As a specific example, the change to the regulatory framework may involve a modification made to a data control defined by the framework involving an access control that is put into place within an entity computing system 180 to manage access to target data stored within the entity computing system 180. Here, the change may entail a new control action that has been added to the access control that involves implementing two-factor authentication for a user to gain access to the target data. Therefore, in this example, the one or more tags may identify that the change involves an access control and a control action for implementing two-factor authentication. In addition, the one or more tags may identify the access control is applicable to data storage that may be used within the entity computing system 180 such as a database.

In various aspects, the process change module 130 may generate one or more tags identifying further characteristics of the regulatory framework and/or data control involved in the change made to the regulatory framework. For example, the process change module 130 may generate one or more tags identifying domain(s) to which the regulatory framework and/or data control are applicable, as well as jurisdiction(s) in which the regulatory framework and/or data control are applicable.

In Operation 225, the monitor change module 110 coordinates one or more actions being performed based on the characteristics identified (e.g., the one or more tags generated) for the change to the regulatory framework. In general, the one or more actions are based on the change to the regulatory framework affecting one or more computing systems' 180 of various entities implementation of data controls defined by the regulatory framework. According to various aspects, the monitor change module 110 performs this particular operation by invoking a perform action module 140 for each entity that has an interest in the regulatory framework.

For example, the monitor change module 110 may reference an entity's subscription profile to determine whether the regulatory framework is applicable to the entity. If so, then the monitor change module 110 may invoke the perform action module 140 for the entity to have one or more actions performed for the entity, if necessary, to address the change made to the regulatory framework.

In turn, the perform action module 140 determines whether the change to the regulatory framework is applicable to one or more computing systems 180 of the entity that are involved in handling target data associated with the regulatory framework. In various aspects, the perform action module 140 may use the characteristics identified (e.g., tags generated) for the change to the regulatory framework and characteristics of the entity found in the entity's subscription profile in determining whether the change is applicable to the entity (e.g., is applicable to one or more computing systems 180 of the entity).

For example, the characteristics identified for the change to the regulatory framework may indicate that the change involves a modification has been made to a data control defined in the framework in which a new control action has been added to the data control. In addition, the characteristics may indicate that the change (e.g., the new control action) is applicable to a particular domain (e.g., the healthcare domain) in a particular jurisdiction (e.g., specifically in the EU). Therefore, the perform action module 140 may compare these characteristics to characteristics found in the entity's subscription profile to see if the entity is operating in the particular domain and has any computing systems 180 handling applicable target data that are implementing data controls defined by the regulatory framework and are located in the particular jurisdiction. If so, then the perform action module 140 may determine the change to the regulatory framework is applicable to the entity.

In various aspects, the monitor change module 110 can coordinate various actions being performed for the particular entity to address the change to the regulatory framework. For instance, if the change involves an addition of a data control to the framework or a modification to a data control in the framework, then the monitor change module 110 may coordinate one or more actions being performed that involve automatically setting up a task to have the data control implemented or implementation thereof modified on the affected computing system(s) for the entity. In other instances, the monitor change module 110 may coordinate one or more actions being performed that involve sending one or more electronic notifications such as emails to personnel of the entity identifying the change to the data control. As previously noted, the entity's subscription profile may provide information (e.g., email addresses) that can be used in sending the notification(s).

As a result, the entity is made aware of the change that has been made to the regulatory framework that affects one or more computing systems 180 of the entity used in handling target data associated with the framework. Therefore, the entity can take the appropriate steps to ensure that the entity's implementation of data controls defined by the regulatory framework within the affected entity computing system(s) 180 is done so in a manner that provide security for the target data in light of the change.

### Detect Change Module

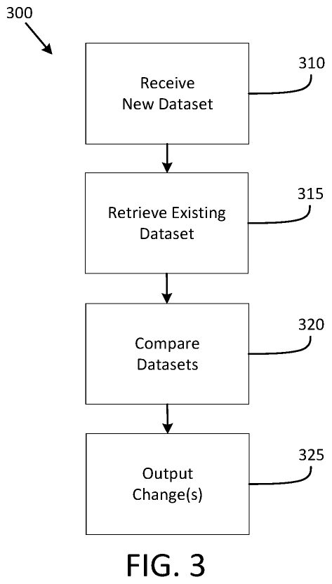

Turning now to FIG. 3, additional details are provided regarding a detect change module 120 for detecting a change to a regulatory framework in accordance with various aspects of the disclosure. For instance, the flow diagram shown in FIG. 3 may correspond to operations carried out, for example, by computing hardware found in the change detection computing system 100 as described herein, as the computing hardware executes the detect change module 120.

In various aspects, the detect change module 120 detects changes made to a regulatory framework by comparing a new (updated) version of a dataset containing content on the regulatory framework with a previous (existing) version of the dataset. Therefore, the process 300 involves the detect change module 120 receiving a new (updated) version of the dataset in Operation 310. For instance, the detect change module 120 may be invoked by the monitor change module 110 and the monitor change module 110 may provide the detect change module 120 with the new (updated) dataset for the regulatory framework. In another instance, the detect change module 120 may retrieve the new (updated) dataset for the regulatory framework, for example, from a repository 160 for the change detection computing system 100.

Likewise, in Operation 315, the detect change module 120 retrieves a previous (existing) version of the dataset for the regulatory framework. Again, the detect change module 120 may retrieve the previous (existing) version of the dataset from a repository 160 for the change detection computing system 100.

At Operation 320, the detect change module 120 compares the two versions of the dataset to identify any differences between the two versions that may identify changes that have been made to the regulatory framework. For example, the dataset may include content defining the data controls that make up the regulatory framework. Therefore, any difference between the two versions of the dataset may indicate that a data control from the framework has been modified, added, removed, and/or the like. In another example, the dataset may include content on bulletins collected from an organization that is responsible for maintaining the regulatory framework. Therefore, any difference between the two versions of the dataset may indicate that a new bulletin has been published for the regulatory framework that may entail a change has been made to the framework such as, for example, a new control action has been added to one of the data controls defined by the framework. In yet another example, the dataset many include articles gathered from various websites that post information on the regulatory framework. Therefore, any difference between the two versions of the dataset may indicate that a new article has been published on the regulatory framework detailing a change that has been made to the framework such as, the framework is now applicable to a new domain.

In various aspects, the detect change module 120 may perform preprocessing on the two versions of the dataset prior to conducting the comparison of the datasets. For example, the detect change module 120 may remove certain punctuation, special characters (e.g., hashes, hyphens, ampersands), and/or the like from the text of the content found in the datasets. In addition, the detect change module 120 may convert the text of the content found in the datasets to the same case (e.g., lowercase). Further, the detect change module 120 may remove stop words from the text of the content, perform stemming on the text of the content, perform normalization on the text of the content, and/or the like. Such preprocessing may aid the detect change module 120 in performing the comparison of the two versions of the dataset to identify differences between the versions of the dataset.

In particular aspects, the detect change module 120 performs the comparison of the two versions of the data set by making use of a text comparison engine (comprising a text comparison algorithm) that compares the text found in the content of the datasets and identifies any differences between the text of the two versions of the dataset. Accordingly, the detect change module 120 may identify a portion of the dataset that includes a change to the dataset. In some aspects, the detect change module 120 may make use of a rules-based model to determine whether a detected change between the versions of the dataset may constitute a change that has been made to the regulatory framework.

For example, the rules-based model may make use of a set of rules in identifying changes found between the two version of the dataset that may be cosmetic in nature, and not necessarily tied to a change to the content on the regulatory framework. For example, a detected change between the two versions of the dataset may simply represent an additional space added to text found in the content, or correction of a typographical error found in the previous (existing) version of the dataset. Therefore, the detect change module 120 may use the rules-based model in identifying such changes so that they may be eliminated from consideration.

At Operation 325, the detect change module 120 outputs the detected changes found between the two versions of the dataset. For example, the detect change module 120 outputs the detected changes to the monitor change module 110. In turn, the monitor change module 110 may then process each of the detected changes and coordinate having one or more actions performed for the changes as previously discussed.

### Process Change Module

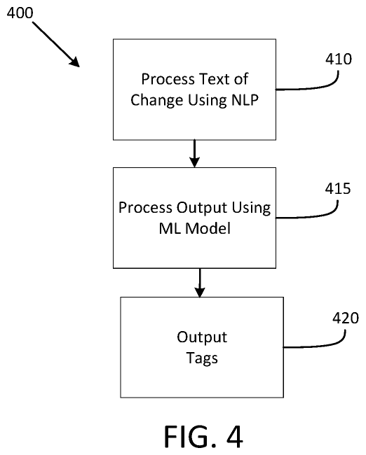

Turning now to FIG. 4, additional details are provided regarding a process change module 130 for processing a change to a regulatory framework in accordance with various aspects of the disclosure. For instance, the flow diagram shown in FIG. 4 may correspond to operations carried out, for example, by computing hardware found in the change detection computing system 100 as described herein, as the computing hardware executes the process change module 130.

The process 400 involves the process change module 130 processing text of the change using natural language processing (NLP) in Operation 410. In various aspects, the process change module 130 performs this operation by performing keyword extraction on the text found in at least a portion of the dataset discussing (describing) the change to the regulatory framework to generate one or more tags representing characteristics of the change to the regulatory framework.

Similar to the detect change module 120, the process change module 130 may perform preprocessing on the portion of the dataset prior to performing keyword extraction of the text found in the portion of the dataset. However, in some instances, the process change module 130 may not be required to performing preprocessing if the detect change module 120 has previously done so on the portion of the dataset.

In various aspects, the process change module 130 processes the portion of the of the dataset using a featurization technique, such as bag of words, TFiDF, Word2Vec, and/or the like, to generate a feature representation of the change to the regulatory framework (e.g., change to the data control). The feature representation includes a plurality of feature attributes representing the content of the change to the regulatory framework. For example, the feature representation may be a vector representation that includes a plurality of values in which each value represents an attribute of the text found in the portion of the dataset discussing the change.

In various aspects, the process change module 130 processes the feature representation using a first machine-learning model to generate a plurality of tags representing characteristics of the change to the regulatory framework. In particular aspects, the first machine-learning model may be a multi-label classification model trained to identify (predict) whether a set of characteristics are found in the portion of the dataset. For example, the first machine-learning model may be configured with a one-versus-rest classifier such as a support vector machine, logistic regression, neural network, and/or the like. The first machine-leaning model may initially generate a feature representation (e.g., vector) having separate attributes representing various characteristics that may exist in the text found in the portion of the dataset. Accordingly, each attribute of the feature representation provides a prediction (e.g., a value) as to whether the corresponding characteristic exists in the text found in the portion of the dataset. Therefore, the first machine-learning model may identify those characteristics corresponding to attributes having values that satisfy a threshold as characteristics found in the text of the portion of the dataset. The first machine-learning model may then use these identified characteristics as those that make up the plurality of tags generated for the change to the regulatory framework.

For example, one or more tags may identify one or more types for a data control associated with the change to the regulatory framework such as a data access control, a data masking control, a data transfer control, and/or the like. In addition, one or more of the tags may identify control actions used in implementing a particular type of data control within a computing system. For example, a control action may involve implementing two-factor authentication for implementing a data access control. Further, one or more of the tags may identify characteristics of a computing system, or components thereof, to which the change to the regulatory framework applies. For example, a particular tag may identify that the change is applicable to a database implementation, a Web server, a particular software application, and/or the like.

At Operation 415, the process change module 130 processes the plurality of tags (e.g., the output generated by the first machine-learning model) using a second machine-learning model to generate one or more additional tags identifying applicable domains and/or applicable jurisdictions in which the change to the regulatory framework applies. As previously noted, a domain may be considered an industry, corporate area, business sector, and/or the like in which an entity (e.g., an organization) operates. For example, an entity may operation in the healthcare domain, the e-commerce domain, the banking domain, the telecommunications domain, and/or the like. The domains in which an entity operations can often define what regulatory frameworks the entity should implement within its computing systems with respect to handling certain types of data. A jurisdiction identifies a territory, region, district, and/or the like in which a regulatory framework is applicable, as well as a location where an entity (e.g., computing system thereof) operates. For example, a jurisdiction may include a portion of the World, a country, a region of a country, a state, and/or the like.

In various aspects, the second machine-learning model may also be a multi-label classification model. In particular aspects, the second machine-learning model is configured as an ensemble comprising a first multi-label classifier to generate a first feature representation comprising attributes representing different domains and a second multi-label classifier to generate a second feature representation comprising attributes representing different jurisdictions. Therefore, each of the attributes of the first feature representation may represent a different domain and contain a prediction (e.g., value) as to whether the change to the regulatory framework is applicable to the corresponding domain. Likewise, each of the attributes of the second feature representation may represent a different jurisdiction and contain a prediction (e.g., value) as to whether the change to the regulatory framework is applicable to the corresponding jurisdiction. The second machine-learning model may then identify the applicable domains and jurisdictions for the change to the regulatory framework as those domains and jurisdictions having predictions (values) satisfying a threshold. Note that the thresholds used for identifying the applicable domains and jurisdictions do not necessarily need to be the same.

Once the process change module 130 has identified the various tags for the change to the regulatory framework, the process change module 130 outputs the tags in Operation 420. As previously noted, the change detection computing system 100 can then use the tags in identifying computing systems 180 of various entities that are affected by the change to the regulatory framework.

### Perform Action Module

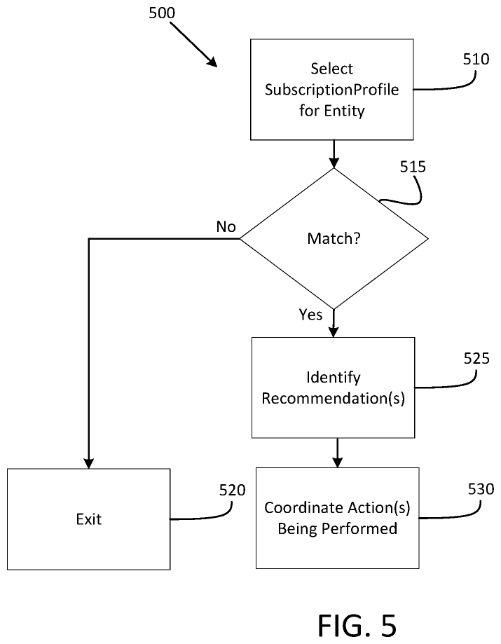

Turning now to FIG. 5, additional details are provided regarding a perform action module 140 for having action(s) performed to address a change to a regulatory framework in accordance with various aspects of the disclosure. For instance, the flow diagram shown in FIG. 5 may correspond to operations carried out, for example, by computing hardware found in the change detection computing system 100 as described herein, as the computing hardware executes the perform action module 140.

As previously noted, the change detection computing system 100 identifies those computing systems 180 of entities that are affected by a change to a regulatory framework and then coordinates (may coordinate) having one or more actions performed to address the change for the identified computing systems 180. Therefore, the change detection computing system 100 (e.g., the monitor change module 110) may invoke the perform action module 140 for each entity in determining whether the entity may have any computing systems 180 affected by the change and if so, to take action(s) accordingly. In particular aspects, the change detection computing system 100 may identify those entities who have indicated (e.g., through their subscription profiles) that the regulatory framework is being used for implementing data controls for various computing systems 180 of the entities and invoke the perform action module 140 for each of those identified entities.

Therefore, the process 500 involves the perform action module 140 selecting the subscription profile for the entity in Operation 510. As previously noted, the change detection computing system 100 can allow for an entity to set up a subscription profile upon subscribing to the change detection service. The subscription profile for the entity may provide information on the domain(s) and/or jurisdiction(s) in which the entity is operating (e.g., computing systems 180 thereof are operating). Therefore, at Operation 515, the perform action module 140 determines whether any of the applicable domain(s) and/or jurisdiction(s) identified for the change to the regulatory framework match any of the domain(s) and/or jurisdiction(s) found in the subscription profile for the entity. If not, then the perform action module 140 exits in Operation 520. However, if an applicable domain and/or jurisdiction does match a domain and/or jurisdiction for the entity, then the perform action module 140 determines whether the change to the regulatory framework affects (may affect) one or more computing systems 180 of the entity.

In some aspects, the perform action module 140 determines whether the entity has a particular computing system 180 affected by the change to the regulatory framework. That is to say, the perform action module 140 determines whether the entity actually has a particular computing system 180 operating in the applicable domain(s) and/or jurisdiction(s). Again, the perform action module 140 may reference the entity's subscription profile in making such a determination. The perform action module 140 may use other characteristics of the change to the regulatory framework (e.g., other tags generated by the process change module 130) and/or characteristics of the entity in determining whether the entity has a particular computing system 180 that is affected by the change.

Therefore, if the perform action module 140 determines the change to regulatory framework affects at least one computing system 180 of the entity, then the perform action module 140 identifies one or more recommendations to address the change in Operation 525. In particular aspects, the perform action module 140 performs this particular operation by invoking an identify recommendation module 150. The identify recommendation module 150 then determines one or more recommendations to provide to the entity in addressing the change to the regulatory framework. In some aspects, the perform action module 140 may not necessarily perform this operation based on the entity. For example, the entity may indicate in its subscription profile to have specific actions performed in response to identifying certain types of changes made to a regulatory framework that affects a computing system 180 of the entity. Therefore, in these instances, the specific actions may not necessitate the perform action module 140 providing the entity with a recommendation for addressing the change.

At Operation 530, the perform action module 140 coordinates one or more actions being performed to address the change to the regulatory framework. In some instances, the perform action module 140 coordinates actions to be performed to address the change to the regulatory framework based on information (preferences) found in the entity's subscription profile. For example, the entity may indicate in its subscription profile that one or more electronic notifications (e.g., emails, text messages, and/or the like) should be sent identifying the change, along with a recommendation for addressing the change. Therefore, the perform action module 140 may reference the entity's subscription profile in determining what actions should be performed to address the change.

Accordingly, the entity may set preferences for certain actions to be performed depending on characteristics of the change and/or characteristics of the computing system(s) 180 affected by the change. For example, the entity may indicate in its subscription profile that for changes to regulatory frameworks that need to be addressed within a brief time (e.g., within thirty days), the perform action module 140 should coordinate an action that involves automatically setting up a task within a data control management software application to have the change implemented. Here, the data control management software application may be a software application managed by the entity (and residing on a computing system 180 of the entity) or provided as part of the change detection computing service. Therefore, the perform action module 140 may coordinate the action by setting up the task in the data control management software application and in some instances, automatically assign the task to personnel of the entity to have the change implemented.

In the same example, the entity's subscription profile may indicate that if the change is not required to be implemented within a brief time (e.g., more than thirty days), then the perform action module 140 should have one or more notifications sent to personnel of the entity identifying the change and providing recommendation(s) for addressing the change. This may be expressed as a timing requirement in the subscription profile. The subscription profile may indicate who is to receive the notifications (e.g., the subscription profile may provide one or more email addresses for personnel). This may be expressed as a personnel requirement in the subscription profile. In addition, the subscription profile may identify conditions for sending the notifications to certain personnel of the entity. For example, if the “severity” of the change is high, then the perform action module 140 is to have a notification sent to a privacy officer for the entity. However, if the “severity” of the change is not high (e.g., medium, or low), then the perform action module 140 is to have the notification sent to system administrator(s) of the entity computing system(s) 180 that are affected by the change to the regulatory framework. This can be expressed as a severity requirement in the subscription profile. The perform action module 140 can use other conditions of the change and/or entity in determining how the notifications are sent such as conditions based on characteristics of the entity computing system(s) 180 that are affected by the change to the regulatory framework.

As noted above, the perform action module 140 may determine a severity (severity level) of the change to the framework. Accordingly, the severity level can be used by the perform action module 140 in determining what actions need to be performed to address the change. As further noted, these actions may be identified by the entity within its subscription profile. The severity level of the change to the regulatory framework can be based on various characteristics of the change and/or computing system(s) 180 affected by the change.

For example, if the change to the regulatory framework involves a change to a data control for managing access to target data, then the perform action module 140 may set a first severity level (e.g., high severity level) for the change. As another example, if the change to the regulatory framework involves a change to a data control for managing the masking of target data, then the perform action module 140 may set a second severity level (e.g., medium severity level) for the change. Similarly, if the change to the regulatory framework involves a change that affects entity computing systems 180 that primarily are used for storing target data, then the perform action module 140 may set a first severity level (e.g., high severity level) for the change. As another example, if the change to the regulatory framework involves a change that affects entity computing systems 180 that primarily are used for collecting target data, then the perform action module 140 may set a second severity level (e.g., medium severity level) for the change. Accordingly, the perform action module 140 may use various characteristics, and/or combinations thereof, in setting a severity level for the change. Further, the perform action module 140 may use various indicators in representing the severity level such as degrees (e.g., high, medium, low,) numerical values (e.g., a range from 1 to 10), colors (e.g., red, yellow, green) and/or the like.

In particular aspects, the perform action module 140 may also determine a priority (priority level) for carrying out the actions to address the change to the regulatory framework. The perform action module 140 may base the priority level on various characteristics of the change to the regulatory framework and/or characteristics of the entity computing system(s) 180 affected by the change. In some aspects, the perform action module 140 may base the priority level on the severity level of the change. In other aspects, the perform action module 140 may base the priority level on more than the severity level of the change.

For example, the perform action module 140 may base the priority level on when the change to the regulatory framework is to take effect. As a specific example, the perform action module 140 may consider whether the change to the regulatory framework is to take effect within a certain period of time (e.g., certain threshold of time) such as in the next thirty days. If so, then the perform action module 140 may set the priority level for the change to high. In addition, the perform action module 140 may take immediate action as a result of setting the priority level to high (or some other priority level) such as, for example, automatically sending a notification (e.g., electronic communication) to personnel of the entity to notify them of the imminent change to the regulatory framework. In another example, the perform action module 140 may base the priority level on what actions are to be performed (e.g., the amount of time required to perform the actions), what types of entity computing system(s) 180 are affected by the change, and/or the like.

In addition, the perform action module 140 may base the priority level on preferences set up by the entity in the entity's subscription profile. For example, the entity may indicate in its profile that a high priority level should be set for changes that need to be addressed within a brief time (e.g., within the next thirty days). Therefore, the perform action module 140 may set a high priority level for the actions that are to be carried out to address the change for the entity. Again, the perform action module 140 may use various indicators in representing the priority level such as “high, medium, low,” a range of numerical values from 1 to 10, “red, yellow, green,” and/or the like.

In various aspects, a suitable computing system, such as the change detection computing system 100 and/or a computing system 180 of an entity, may perform the actions necessary to address the change to the regulatory framework. For example, the perform action module 140 may coordinate setting up one or more tasks may in a data control management software application that are to be performed to address a change to a regulatory framework. Here, the data control management software application may reside in a suitable computing system such as the change detection computing system 100 or a computing system 180 for an entity affected by the change. In another example, a suitable computing system may perform an automated action to assist in addressing the change to the regulatory framework. For example, the change detection computing system 100 may send an electronic notification to a suitable system to have a particular action performed to address the change. Here, the suitable computing system may be a computing system 180 associated with the entity that then automatically performs the action to address the change to the regulatory framework.

As a specific example, the change to the regulatory framework may involve a change made to a data control for controlling (managing) access to target data stored in a database found in a first computing system 180 of an entity. Specifically, the change to the data control may involve adding a new control action that entails installing an additional layer of authentication for an individual to gain access to the target data stored in the database. Therefore, the change detection computing system 100 may send an electronic notification to a second computing system 180 of the entity identifying the change to the regulatory framework. In turn, the second computing system 180 receiving the notification may initially suspend access to the database found in the first computing system 180 for the entity. In addition, the second computing system 180 may send a notification to a privacy officer for the entity informing the officer of the change to the regulatory framework. Further, the second computing system 180 may automatically set up one or more tasks within a data control management software application to have the new control action implemented for the database, as well as assigning the task(s) to personnel of the entity to perform. Therefore, in this example, the second computing system 180 of the entity serves as the suitable computing system for coordinating and/or performing the actions necessary to address the change made to the regulatory framework.

In other instances, the change detection computing system 100 may not send the notification but instead may serve as the suitable computing system in coordinating and/or performing the actions as described above in the specific example. Here, the change detection computing system 100 may be provided with credentials by the entity (e.g., via through the entity's subscription profile) for coordinating and/or performing the actions.

Finally, in various aspects, a suitable computing system (e.g., the change detection computing system 100 or a computing system 180 for an entity) can provide one or more graphical user interfaces for tracking and managing changes made to various regulatory frameworks. For example, the change detection computing system 100 may provide the one or more graphical user interfaces as part of the change detection service to which entities subscribe as previously discussed. Therefore, in this example, personnel for the entities may access the graphical user interface(s) over a network 170 (e.g., the graphical user interface(s) may be provided as one or more webpage accessible over the Internet) and view information on the changes to regulatory framework identified as affecting computing systems 180 for the entities.

### Identify Recommendation Module

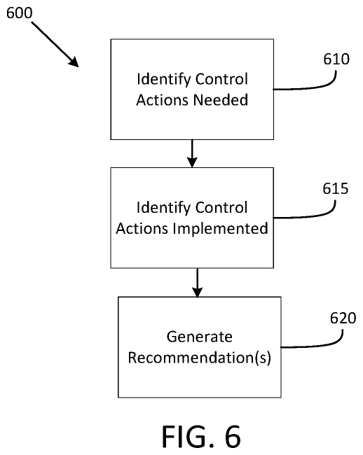

Turning now to FIG. 6, additional details are provided regarding an identify recommendation module 150 for identifying recommendations to address a change to a regulatory framework in accordance with various aspects of the disclosure. For instance, the flow diagram shown in FIG. 6 may correspond to operations carried out, for example, by computing hardware found in the change detection computing system 100 as described herein, as the computing hardware executes the identify recommendation module 150.

In various aspects, the change detection computing system 100 may provide an entity with one or more recommendations to address a change to a regulatory framework the change detection computing system 100 has identified as affecting one or more computing systems 180 of the entity. In these instances, the change detection computing system 100 (e.g., the perform action module 140) may invoke the identify recommendation module 150 to identify the recommendations to provide to the entity. The change detection computing system 100 (e.g., the perform action module 140) may provide the identify recommendation module 150 with information on the change such as, for example, characteristics of the change that has been made to the regulatory framework (e.g., the tags generated by the process change module 130) and/or characteristics of the entity and/or computing system(s) 180 of the entity affected by the change.

In various aspects, the identify recommendation module 150 provides recommendation(s) to the entity that are generally contingent on the characteristics of the change to the regulatory framework. For example, the change to the regulatory framework may be that the framework is now applicable to a domain (e.g., e-commerce domain) that the framework was not necessarily applicable to in the past. Therefore, in this example, the identify recommendation module 150 may provide a recommendation to an entity to implement data controls defined by the framework since the entity operates in the newly applicable domain.

In another example, the change to the regulatory framework may not only affect one or more computing systems 180 of the entity, but may also conflict with another regulatory framework that is of interest (that is applicable) to the entity. As a specific example, the change made to the regulatory framework may entail requiring the implementation of a first encryption technique on target data. However, a second regulatory framework that is of interest (that is applicable) to the entity may require the implementation of a second, different encryption technique for the target data. Therefore, the identify recommendation module 150 may provide a recommendation to the entity that points out the conflict between the two regulatory frameworks as a result of the change.

However, often the change to the regulatory framework entails a change made to a data control (and/or control action thereof) defined by the framework. Thus, the identify recommendation module 150 may provide a recommendation to the entity that typically entails addressing a change made to a data control (and/or control action thereof). Therefore, in various aspects, the process 600 involves the identify recommendation module 150 identifying the control actions needed to implement the data control involved in the change to the regulatory framework in Operation 610. For example, the change may entail the addition of a data control, or a modification made to a data control defined by the regulatory framework. Here, the entity may need to perform control actions to implement the newly added or modified data control that has been added to the regulatory framework or modified in the regulatory framework. As a specific example, the change may entail a modification has been made to a data control indicating that target data now needs to be stored in a secure manner by encoding the target data.

In particular aspects, the identify recommendation module 150 may use a rules-based model in identifying the one or more control actions needed in implementing the change made to the data control. The rules-based model may utilize a set of rules that identify the control actions needed to be carried out to implement a particular data control that has been added or modified as indicated by the change to the regulatory framework. Therefore, the identify recommendation module 150 may process characteristics of the change (e.g., one or more of the tags generated by the process change module 130) using the rules-based model to generate the one or more control actions that need to be performed to implement the change to the data control.

For instance, in the specific example, the identify recommendation module 150 may process characteristics of the change indicating that the target data now needs to be stored as encoded data using the rules-based model. In turn, the rules-based model may generate a control action of having the target data encrypted prior to storing the data.

In some aspects, the identify recommendation module 150 may provide characteristics of the entity computing system(s) 180 affected by the change to the rules-based model in generating the control actions that need to be performed to implement the change. For example, the entity computing system 180 that is affected by the change may be using a PostgreSQL database in storing the target data. Therefore, the rules-based model may generate a control action that involves encrypting the target data using a specific encryption technique based on the database being a PostgreSQL database.

In particular aspects, the identify recommendation module 150 may provide the identified control action(s) as the recommendation(s) for addressing the change to the regulatory standard. In addition, the identify recommendation module 150 may provide an exception for identified changes in which the identify recommendation module 150 is unable to the identify a recommendation to address the changes. These exceptions may assist in updating the set of rules utilized by the rules-based model in identifying recommendations to address changes made to regulatory frameworks.

In some aspects, the identify recommendation module 150 may take into consideration what control actions the entity has already implemented with respect to the affected computing system(s) of the entity in providing the recommendation(s). Therefore, in Operation 615, the identify recommendation module 150 identifies the control actions already implemented for the computing system(s) 180 of the entity that are affected by the change.

Accordingly, the identify recommendation module 150 may retrieve information on the control actions already implemented by the entity from various sources. In one example, the change detection computing system 100 (e.g., the identify recommendation module 150) may retrieve such information from the entity's subscription profile. In another example, the change detection computing system 100 (e.g., the identify recommendation module 150) may access such information found within the entity computing system(s) 180 affected by the change. For instance, returning to the specific example, the change detection computing system 100 may access metadata (e.g., a schema) for the database found in the entity computing system 180 that is used for storing the target data to determine what control actions for the data control involving the secure storage of the target data have already been implemented for the database.

In Operation 620, the identify recommendation module 150 generates the one or more recommendations for addressing the change to the regulatory framework. If the identify recommendation module 150 has acquired information on the control actions already implemented for the entity computing system(s) 180 affected by the change, then the identify recommendation module 150 may generate the recommendation(s) based on the control actions that have already been implemented by the entity. For instance, returning to the specific example, the identify recommendation module 150 may determine that the entity is already encrypting the target data prior to storing the data in the database. However, the identify recommendation module 150 may determine that the entity is not using the encryption technique identified as needed to properly implement the change to the data control. Therefore, the identify recommendation module 150 may generate a recommendation that a control action needs to be carried out to have the target data encrypted using the specific encryption technique.

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

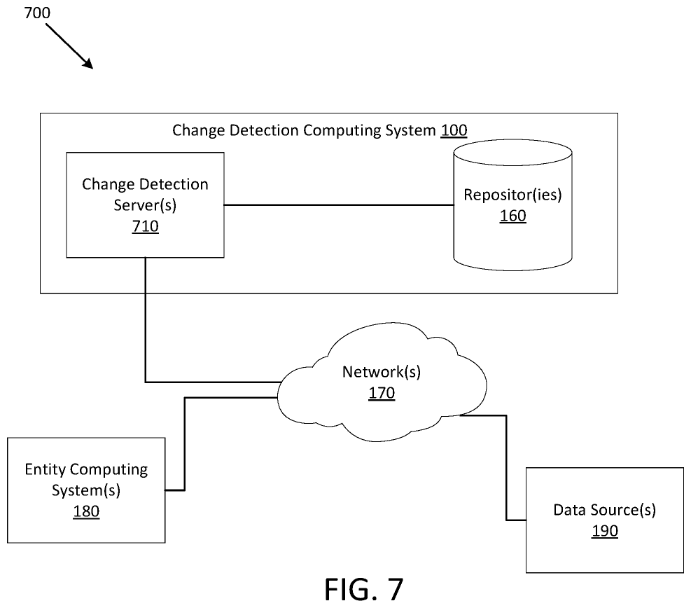

FIG. 7 is a block diagram of a system architecture 700 that can be used in conducting the change detection service according to various aspects of the disclosure as detailed herein. Components of the system architecture 700 are configured according to various aspects to assist entities in identifying changes made to one or more regulatory frameworks applicable to computing systems 180 used by the entities in handling target data. As may be understood from FIG. 7, the system architecture 700 in various aspects may include a change detection computing system 100 that comprises one or more change detection servers 710 and one or more data repositories 160. For example, the one or more data repositories 160 may include a data repository for storing subscription profiles for various entities and a repository for storing information on various regulatory frameworks as described herein. Although the change detection server(s) 710 and repository(ies) 160 are shown as separate components, it should be understood that according to other aspects, these components 710, 160 may comprise a single server and/or repository, a plurality of servers and/or repositories, one or more cloud-based servers and/or repositories, or any other suitable configuration.

The change detection server(s) 710 may communicate with, access, and/or the like one or more computing systems 180 of the entities over one or more networks 170. In addition, the change detection server(s) 710 may communication with, access, and/or the like one or more data sources 190 over one more networks 170 to acquire information on various regulatory frameworks. Further, the change detection server(s) 710 may execute a monitor change module 110, detect change module 120, process change module 130, perform action module 140, and/or identify recommendation module 150 as described herein. Further, in particular aspects, the change detection server(s) 710 provide one or more graphical user interfaces and other interfaces through which personnel of the entities interact with the change detection computing system 100, as well as allowing the change detection computing system 100 to communicate with the computing system(s) 180 of the entities. Thus, the change detection server(s) 710 may interface with the computing system(s) 180 via one or more suitable application programming interfaces (APIs), direct connections, and/or the like.

### Example Computing Hardware

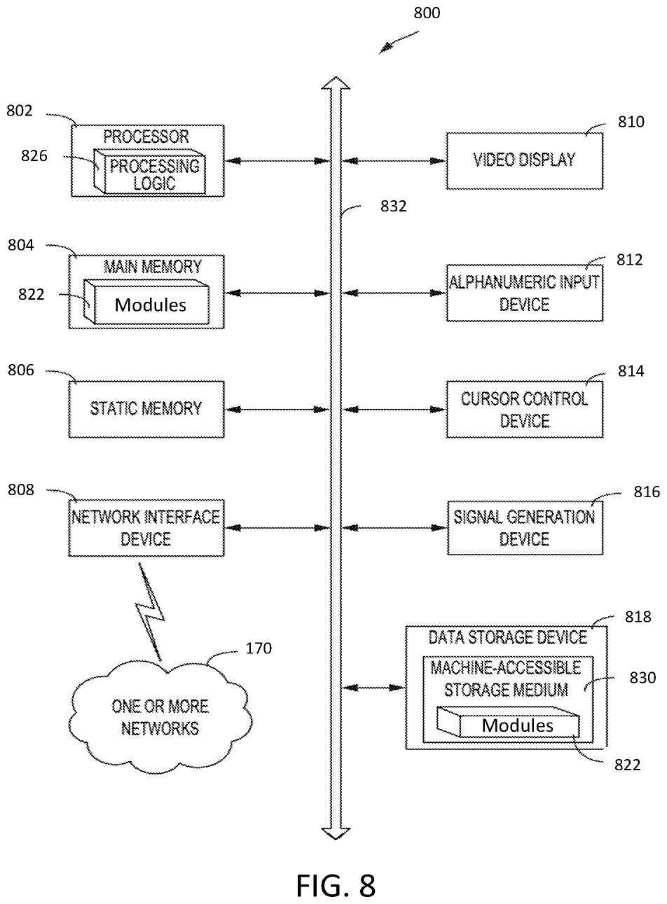

FIG. 8 illustrates a diagrammatic representation of a computing hardware device 800 that may be used in accordance with various aspects of the disclosure. For example, the hardware device 800 may be computing hardware such as a change detection server 710 as described in FIG. 7. According to particular aspects, the hardware device 800 may be connected (e.g., networked) to one or more other computing entities, storage devices, and/or the like via one or more networks such as, for example, a LAN, an intranet, an extranet, and/or the Internet. As noted above, the hardware device 800 may operate in the capacity of a server and/or a client device in a client-server network environment, or as a peer computing device in a peer-to-peer (or distributed) network environment. According to various aspects, the hardware device 800 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 800 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 800 includes a processor 802, a main memory 804 (e.g., read-only memory (ROM), flash memory, dynamic random-access memory (DRAM) such as synchronous DRAM (SDRAM), Rambus DRAM (RDRAM), and/or the like), a static memory 806 (e.g., flash memory, static random-access memory (SRAM), and/or the like), and a data storage device 818, that communicate with each other via a bus 832.

The processor 802 may represent one or more general-purpose processing devices such as a microprocessor, a central processing unit, and/or the like. According to some aspects, the processor 802 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 802 may be one or more special-purpose processing devices such as an application specific integrated circuit (ASIC), a field programmable gate array (FPGA), a digital signal processor (DSP), network processor, and/or the like. The processor 802 can execute processing logic 826 for performing various operations and/or steps described herein.

The hardware device 800 may further include a network interface device 808, as well as a video display unit 810 (e.g., a liquid crystal display (LCD), a cathode ray tube (CRT), and/or the like), an alphanumeric input device 812 (e.g., a keyboard), a cursor control device 814 (e.g., a mouse, a trackpad), and/or a signal generation device 816 (e.g., a speaker). The hardware device 800 may further include a data storage device 818. The data storage device 818 may include a non-transitory computer-readable storage medium 830 (also known as a non-transitory computer-readable storage medium or a non-transitory computer-readable medium) on which is stored one or more modules 822 (e.g., sets of software instructions) embodying any one or more of the methodologies or functions described herein. For instance, according to particular aspects, the modules 822 include a monitor change module 110, detect change module 120, process change module 130, perform action module 140, and/or identify recommendation module 150 as described herein. The one or more modules 822 may also reside, completely or at least partially, within main memory 804 and/or within the processor 802 during execution thereof by the hardware device 800—main memory 804 and processor 802 also constituting computer-accessible storage media. The one or more modules 822 may further be transmitted or received over a network 170 via the network interface device 808.

While the computer-readable storage medium 830 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 800 and that causes the hardware device 800 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

The disclosure provided herein entails detecting and addressing changes made to regulatory frameworks that affect (may affect) computing systems of various entities. However, those of ordinary skill in the art should appreciate that aspects of the disclosure may be used in detecting and addressing changes made to other regulatory instruments such as regulatory laws, regulations, standards, and/or the like that may also affect computing systems of various entities in handling certain types of data (e.g., target data).

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects also may be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

1. A method comprising:
comparing, by computing hardware, a first version of a dataset describing a regulatory framework to a second version of the dataset describing the regulatory framework to identify a change to a data control defined in the regulatory framework, wherein the data control is used in handling target data;
responsive to identifying the change to the data control:
processing, by the computing hardware and using a featurization technique, at least a portion of the dataset describing the regulatory framework to generate a feature representation of the change to the data control, wherein the portion of the dataset comprises content on the change to the data control and the feature representation comprises a plurality of feature attributes representing the content of the change to the data control;
processing, by the computing hardware and using a first machine-learning model, the feature representation of the change of the data control to generate a plurality of tags, wherein the plurality of tags represents characteristics of the change made to the data control;
processing, by the computing hardware and using a second machine-learning model, the plurality of tags to generate at least one of an applicable domain or an applicable jurisdiction for the data control;
identifying, by the computing hardware and based on the at least one of the applicable domain or the applicable jurisdiction, a computing system used in handling the target data that is affected by the change to the data control; and
responsive to identifying the computing system, coordinating, by the computing hardware, an action to be performed with respect to the computing system to address the change to the data control.

2. The method of claim 1, wherein the change to the data control comprises an addition of a control action performed for implementing the data control and the action comprises automatically setting up a task to have the control action performed on the computing system.

3. The method of claim 1, wherein the change to the data control comprises a modification to a control action performed for implementing the data control and the action comprises automatically setting up a task to have the modification of the control action performed on the computing system.

4. The method of claim 1, wherein the action comprises sending an electronic notification of the change to the data control to an entity associated with the computing system.

5. The method of claim 4 further comprising determining, by the computing hardware, a priority level associated with the change to the data control, wherein the priority level is based on a requirement for implementing the change to the data control and at least one of a timing for sending the electronic notification or a recipient of the electronic notification is based on the priority level.

6. The method of claim 1, wherein the action comprises:
identifying, by the computing hardware, the change in the data control comprises a new control action needed to be performed to implement the data control; and
sending an electronic notification comprising a recommendation based on the new control action to an entity associated with the computing system.

7. The method of claim 1, wherein identifying, based on the at least one of the applicable domain or the applicable jurisdiction, the computing system used in handling the target data that is affected by the change to the data control comprises:
retrieving a subscription profile of an entity associated with the computing system, wherein the subscription profile identifies at least one of a domain in which the entity operates or a jurisdiction in which the computing system is located; and
comparing at least one of the applicable domain to the domain or the applicable jurisdiction to the jurisdiction to determine a match between the at least one of the applicable domain and the domain or the applicable jurisdiction and the jurisdiction.

8. The method of claim 1, wherein the action is performed based on identifying the regulatory framework from a subscription profile for an entity associated with the computing system.

9. A system comprising:
a non-transitory computer-readable medium storing instructions; and
a processing device communicatively coupled to the non-transitory computer-readable medium,
wherein, the processing device is configured to execute the instructions and thereby perform operations comprising:
comparing a first version of a dataset describing a regulatory framework to a second version of the dataset describing the regulatory framework to identify a change to a data control defined in the regulatory framework, wherein the data control is used in handling target data;
responsive to identifying the change to the data control:
processing, using a featurization technique, at least a portion of the dataset describing the regulatory framework to generate a feature representation of the change to the data control, wherein the feature representation comprises a plurality of feature attributes representing at least the portion of the dataset;
processing, using a first machine-learning model, the feature representation of the change of the data control to generate a plurality of tags, wherein the plurality of tags represents characteristics of the change made to the data control;
processing, using a second machine-learning model, the plurality of tags to generate at least one of an applicable domain or an applicable jurisdiction for the data control;
identifying, based on the at least one of the applicable domain or the applicable jurisdiction, a computing system used in handling the target data that may be affected by the change to the data control; and
responsive to identifying the computing system, coordinating an action to be performed with respect to the computing system to address the change to the data control.

10. The system of claim 9, wherein the change to the data control comprises at least one of an addition of or modification to a control action performed for implementing the data control and the action comprises automatically setting up a task to have the control action performed on the computing system.

11. The system of claim 9, wherein the action comprises sending an electronic notification of the change to the data control to an entity associated with the computing system.

12. The system of claim 9, wherein the operations further comprise determining a priority level associated with the change to the data control, and coordinating the action to be performed is based on the priority level.

13. The system of claim 9, wherein the action comprises sending an electronic notification comprising a recommendation based on the change to the data control to an entity associated with the computing system.

14. The system of claim 9, wherein identifying, based on the at least one of the applicable domain or the applicable jurisdiction, the computing system used in handling the target data that may be affected by the change to the data control comprises:
retrieving a subscription profile of an entity associated with the computing system, wherein the subscription profile identifies at least one of a domain in which the entity operates or a jurisdiction in which the computing system is located; and
comparing at least one of the applicable domain to the domain or the applicable jurisdiction to the jurisdiction to determine a match between the at least one of the applicable domain and the domain or the applicable jurisdiction and the jurisdiction.

15. The system of claim 9, wherein the action is performed based on identifying the regulatory framework from a subscription profile for an entity associated with the computing system.

16. A non-transitory computer-readable medium storing computer-executable instructions that, when executed by computing hardware, configure the computing hardware to perform operations comprising:
comparing a first version of a regulatory framework to a second version of the regulatory framework to identify a change to a data control defined in the regulatory framework;
responsive to identifying the change to the data control:
processing at least a portion of the regulatory framework to generate a feature representation of the change to the data control, wherein the portion of the regulatory framework comprises content on the change to the data control and the feature representation comprises a plurality of feature attributes representing the content of the change to the data control;
processing the feature representation of the change of the data control to generate a plurality of tags, wherein the plurality of tags represents characteristics of the change made to the data control;
processing the plurality of tags to generate at least one of an applicable domain or an applicable jurisdiction for the data control;
identifying, based on the at least one of the applicable domain or the applicable jurisdiction, a computing system that is affected by the change to the data control; and
responsive to identifying the computing system, coordinating an action to be performed with respect to the computing system to address the change to the data control.

17. The non-transitory computer-readable medium of claim 16, wherein the change to the data control comprises at least one of an addition of or a modification to a control action performed for implementing the data control and the action comprises automatically setting up a task to have the control action performed on the computing system.

18. The non-transitory computer-readable medium of claim 16, wherein the action comprises sending an electronic notification of the change to the data control to an entity associated with the computing system.

19. The non-transitory computer-readable medium of claim 18, wherein the operations further comprise determining a priority level associated with the change to the data control that is based on a requirement for implementing the change to the data control, and at least one of a timing for sending the electronic notification or a recipient of the electronic notification is based on the priority level.

20. The non-transitory computer-readable medium of claim 16, wherein identifying, based on the at least one of the applicable domain or the applicable jurisdiction, the computing system that is affected by the change to the data control comprises:
retrieving a subscription profile of an entity associated with the computing system, wherein the subscription profile identifies at least one of a domain in which the entity operates or a jurisdiction in which the computing system is located; and
comparing at least one of the applicable domain to the domain or the applicable jurisdiction to the jurisdiction to determine a match between the at least one of the applicable domain and the domain or the applicable jurisdiction and the jurisdiction.
